(19) United States
(12) Patent Application Publication
(10) Pub. No.: US 2024/0117974 A1
(43) Pub. Date: Apr. 11, 2024

(54) ROTARY WHEEL HUMIDITY REGULATING DEVICE, AIR CONDITIONING SYSTEM HAVING SAME, CONTROL METHOD, AND CONTROLLER

(71) Applicants: GD MIDEA HEATING & VENTILATING EQUIPMENT CO., LTD., FOSHAN (CN); MIDEA GROUP CO., LTD., FOSHAN (CN)

(72) Inventors: Yu JIANG, FOSHAN (CN); Xuannan WU, FOSHAN (CN); Yusheng ZHANG, FOSHAN (CN); Yunxiao DING, FOSHAN (CN)

(21) Appl. No.: 18/262,194

(22) PCT Filed: Sep. 14, 2021
(86) PCT No.: PCT/CN2021/118129

§ 371 Date: Jul. 20, 2023

(30) Foreign Application Priority Data
Jan. 20, 2021 (CN) 202110077765.5

(51) Int. Cl. F24F 1/0063; F24F 1/16; F24F 1/32; F24F 11/64; F24F 11/65; F24F 11/77; F24F 11/84; F24F 11/88

(52) U.S. Cl. CPC F24F 1/0063; F24F 1/16; F24F 1/32; F24F 11/64; F24F 11/65; F24F 11/77; F24F 11/84; F24F 11/88; F24F 2110/10

(57) ABSTRACT

A rotary wheel humidity regulating device, an air conditioning system having same, a control method for an air conditioning system, and a controller. The rotary wheel humidity regulating device includes an adsorption rotary wheel, a first heat exchanger, and a second heat exchanger. The adsorption rotary wheel has a first portion located at an air inlet side of a fresh air system of an air conditioning system and a second portion located at an air return side of the fresh air system. The first heat exchanger is disposed at a position on the air return side, is in communication with a refrigerant circuit of the air conditioning system, and is controlled for cooling or heating by the air conditioning system through the refrigerant circuit. The second heat exchanger is disposed at a position on the air inlet side close to the first portion, is in communication with the refrigerant circuit, and is controlled for cooling or heating by the air conditioning system through the refrigerant circuit.

### CROSS-REFERENCES TO RELATED APPLICATIONS

The present disclosure is a national phase application of International Application No. PCT/CN2021/118129, filed on Sep. 14, 2021, which claims priority to Chinese Patent Application No. 202110077765.5 filed on Jan. 20, 2021, the entireties of which are herein incorporated by reference.

### FIELD

The present disclosure relates to the field of air conditioners, and more particularly, to a rotary wheel humidity regulating device, an air conditioning system having same, a control method, and a controller.

### BACKGROUND

This section provides only background information related to the present disclosure, which is not necessarily the related art.

With the development of air conditioning technology, a user's demand for temperature regulation has been basically satisfied, and the user's demand for humidity is now increasingly high. Medical studies show that when an ambient temperature ranges from 20° C. to 25° C. and relative humidity of air reaches 45% to 65%, a human body and mind are in an optimal state, to achieve an ideal effect both at work and at rest. In winter, an indoor temperature is increased by a heat-pump-type air conditioner in a case where a moisture content of the air remains constant, leading to a reduction in indoor relative humidity. In addition, this often results in tight skin, dry mouth and tongue, coughs and colds, and other air conditioning sickness. For a conventional air conditioner, in summer, it is possible to concurrently reduce an evaporation temperature and humidity in the air in a condensation and dehumidification mode. However, the temperature and the humidity may not be simultaneously regulated to a comfortable range under most operation conditions in this dehumidification mode. In one embodiment, energy efficiency of the air conditioner is limited due to the lower evaporation temperature required for dehumidification.

For the above problems, some manufacturer uses the principle of an adsorption rotary wheel and builds a humidification system in combination with electrical heating, to realize adsorption and desorption of moisture and settle problems of dehumidification in summer and humidification in winter, respectively. According to the above solutions, the problem of indoor humidity in summer and winter can be solved to some extent, but efficiency is very low when the desorption of moisture in the rotary wheel is achieved by the electrical heating. The root cause of the low efficiency is that commonly used materials for the rotary wheel are mostly silica gel and zeolite, a temperature required for the desorption of moisture is more than 100° C., and a conventional low-grade heat source is difficult to use. Meanwhile, after dehumidified air is subjected to high-temperature regeneration, the air has a high temperature and is required to be cooled by additionally cooperating with a low-temperature cold source to be fed indoors. As a result, an air conditioning system has extremely complex construction.

### SUMMARY

The embodiments of the present disclosure a rotary wheel humidity regulating device is provided. The rotary wheel humidity regulating device includes an adsorption rotary wheel, a first heat exchanger, and a second heat exchanger. The adsorption rotary wheel has a first portion located at an air inlet side of a fresh air system of an air conditioning system and a second portion located at an air return side of the fresh air system. The first heat exchanger is disposed at a position on the air return side close to the second portion at the air return side. The first heat exchanger is in communication with a refrigerant circuit of the air conditioning system and controlled for cooling or heating by the air conditioning system through the refrigerant circuit. The second heat exchanger is disposed at a position on the air inlet side close to the first portion at the air inlet side. The second heat exchanger is in communication with the refrigerant circuit and controlled for cooling or heating by the air conditioning system through the refrigerant circuit.

According to a further embodiment of the present disclosure an air conditioning system is provided. The air conditioning system includes a refrigerant circuit and a fresh air system. The refrigerant circuit is formed by a series connection of a compressor, an outdoor heat exchanger, a throttling device, and an indoor heat exchanger. The refrigerant circuit is in thermal contact with an indoor unit air circuit of the air conditioning system. The fresh air system includes the rotary wheel humidity regulating device as described in the above embodiment. The rotary wheel humidity regulating device is connected to the refrigerant circuit and the indoor unit air circuit.

According to yet another embodiment of the present disclosure a control method for an air conditioning system is provided. The control method is implemented by the air conditioning system as described in the above embodiments and includes: obtaining target humidity and real-time humidity of the air conditioning system; controlling the first heat exchanger of the air conditioning system to operate in a condensation mode and the second heat exchanger of the air conditioning system to operate in an evaporation mode, when the real-time humidity is greater than the target humidity and the fresh air system of the air conditioning system is in a fresh air dehumidification mode; and controlling the first heat exchanger of the air conditioning system to operate in the evaporation mode and the second heat exchanger of the air conditioning system to operate in the condensation mode, when the real-time humidity is less than the target humidity and the fresh air system is in a fresh air humidification mode.

### BRIEF DESCRIPTION OF THE DRAWINGS

In the accompanying drawings:

FIG. 1 is a schematic structural view of a rotary wheel humidity regulating device according to an embodiment of the present disclosure;

FIG. 2 is a schematic structural view of an air conditioning system according to an embodiment of the present disclosure;

FIG. 3 is a workflow graph of a fresh air dehumidification mode on an enthalpy-humidity chart according to an embodiment of the present disclosure;

FIG. 4 is a workflow graph of a fresh air humidification mode on an enthalpy-humidity chart according to an embodiment of the present disclosure;

FIG. 5 is a system diagram showing the air conditioning system illustrated in FIG. 2;

FIG. 6 is a schematic structural view of the air conditioning system illustrated in FIG. 5 in a main cooling mode;

FIG. 7 is a schematic structural view of the air conditioning system illustrated in FIG. 5 in a main heating mode;

FIG. 8 is a schematic structural view of a rotary wheel humidity regulating device according to another embodiment of the present disclosure;

FIG. 9 is a flowchart of a control method for an air conditioning system according to an embodiment of the present disclosure;

FIG. 10A to FIG. 10C are flowcharts of a control method for an air conditioning system according to another embodiment of the present disclosure;

FIG. 11 is a structural block diagram of a controller according to an embodiment of the present disclosure;

FIG. 12 is a structural block diagram of a control device of an air conditioning system according to an embodiment of the present disclosure;

FIG. 13 is a structural block diagram of a control device of an air conditioning system according to another embodiment of the present disclosure.

### DETAILED DESCRIPTION OF THE DISCLOSURE

Exemplary embodiments of the present disclosure will be described in more detail below with reference to the accompanying drawings. While the exemplary embodiments of the present disclosure are illustrated in the accompanying drawings, it should be understood that the present disclosure may be embodied in various forms and should not be construed as being limited to the embodiments set forth herein. Instead, these embodiments are provided for a complete and thorough understanding of the present disclosure, and can fully convey the scope of the present disclosure. It should be noted that the rotary wheel humidity regulating device in the present disclosure is not only limited to the application of a three-pipe heat-recovery multi-split system, but is also applicable to other types of air conditioning systems. In addition, such adjustments fall within the scope of the rotary wheel humidity regulating device in the present disclosure.

It can be appreciated that terms used in the present disclosure are only for a purpose of describing implementations of specific examples, and are not intended to limit the present disclosure. Singular forms of “a”, “one” and “said” used in the present disclosure and the appended claims also include plural forms, unless the context clearly indicates other meanings. The terms “comprising”, “including”, and “having” are inclusive and therefore specify the presence of stated features, elements, and/or components, but do not exclude the presence or addition of one or more other features, elements, components, and/or combinations thereof.

For convenience of description, spatially relative terms may be used herein to describe the relationship of an element or feature to another element or feature as illustrated in the drawings, such as “upper”, “inner”, “end”, “outer”, or “side”. Such spatially relative terms are intended to include different orientations of mechanisms in use or operation except those depicted in the drawings. For example, if the mechanisms in the drawings are rotated, elements described as “below other elements or features” or “under other elements or features” will be oriented “above other elements or features” or “over other elements or features”. Therefore, the exemplary term “under” may include an orientation on top and bottom. The mechanism may be otherwise oriented (rotated by 90 degrees or in other directions) and spatially relative descriptors used in the present disclosure are interpreted accordingly.

It should be noted that “fresh air humidity regulation” according to an embodiment of the present disclosure refers to that outdoor fresh air is fed into an indoor space after passing through the rotary wheel humidity regulating device, and indoor return air passes through the rotary wheel humidity regulating device and then is discharged outdoors. In an embodiment of the present disclosure, “return air humidity regulation” refers to that the outdoor fresh air is discharged outdoors after passing through the rotary wheel humidity regulating device, and the indoor return air is fed into the indoor space after passing through the rotary wheel humidity regulating device.

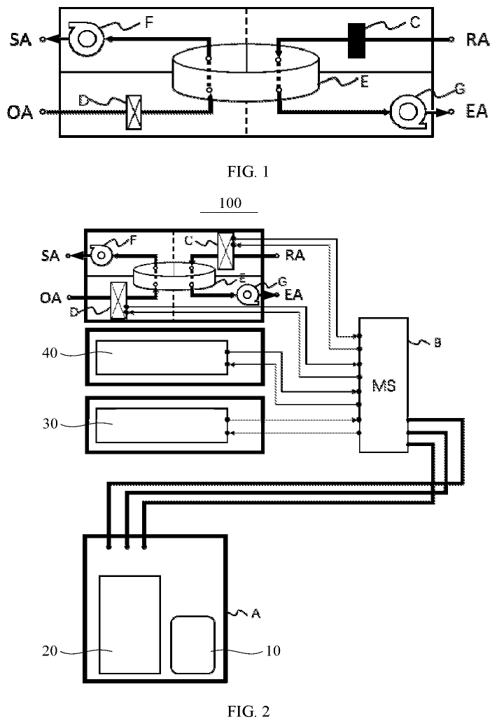

As illustrated in FIG. 1, according to one embodiment of the present disclosure, provided is a rotary wheel humidity regulating device. The rotary wheel humidity regulating device includes an adsorption rotary wheel E, a first heat exchanger C, and a second heat exchanger D. The adsorption rotary wheel E has a first portion located at an air inlet side of a fresh air system of an air conditioning system and a second portion located at an air return side of the fresh air system. The first heat exchanger C is disposed at a position on the air return side close to the second portion of the adsorption rotary wheel E. The first heat exchanger C is in communication with a refrigerant circuit of the air conditioning system and is controlled for cooling or heating by the air conditioning system through the refrigerant circuit. The second heat exchanger D is disposed at a position on the air inlet side close to the first portion of the adsorption rotary wheel E. The second heat exchanger D is in communication with the refrigerant circuit and is controlled for cooling or heating by the air conditioning system through the refrigerant circuit.

In this embodiment, a low-temperature heat source generated by the air conditioning system may be used by the rotary wheel humidity regulating device according to the present disclosure for adsorption and desorption of moisture. Materials used by the adsorption rotary wheel E include, but are not limited to, silicone, molecular sieves, sodium polyacrylate, MOF (metal-organic frameworks), or mesoporous silicone. Relative humidity of air at an intake side and a moisture absorption amount are increased by placing a heat exchanger in an evaporation mode for cooling at a moisture absorption side of the adsorption type rotating wheel E (a specific position of the moisture absorption side is changed as required for humidity regulation). Meanwhile, a heat exchanger in a condensation mode is placed at a moisture release side for heating air, achieving an effect of regenerating the moisture in the adsorption rotary wheel E. In an embodiment of the present disclosure, energy of the air conditioning system is fully utilized without an additional electrical heating device. Therefore, it is possible to significantly improve energy efficiency of the air conditioning system. Meanwhile, a problem of poor humidity control of the air conditioning system can be solved. Therefore, an effect of independent control of temperature and humidity can be obtained.

FIG. 2 shows a schematic structural view of an air conditioning system 100 according to an embodiment of the present disclosure. As illustrated in FIG. 2, the air conditioning system 100 includes a refrigerant circuit and a fresh air system in a fresh air humidity regulation mode. The refrigerant circuit is formed by a series connection of a compressor 10, an outdoor heat exchanger 20, a throttling device, an indoor heating heat exchanger 30, and an indoor cooling heat exchanger 40. The fresh air system includes the rotary wheel humidity regulating device according to one embodiment of the present disclosure. Components illustrated in FIG. 2 are marked as follows. An outdoor unit of the air conditioning system is denoted by A. An MS refrigerant distributor of the air conditioning system is denoted by B. A first heat exchanger of the rotary wheel humidity regulating device is denoted by C. A second heat exchanger of the rotary wheel humidity regulating device is denoted by D. An adsorption rotary wheel of the rotary wheel humidity regulating device is denoted by E. An air supply side fan of the rotary wheel humidity regulating device is denoted by F. An exhaust side fan of the rotary wheel humidity regulating device is denoted by G. Outdoor fresh air is denoted by OA. Indoor return air is denoted by RA. Indoor supply air is denoted by SA. Outdoor exhaust air is denoted by EA.

In some embodiments, an indoor air return pipe and an outdoor exhaust pipe are disposed at the air return side of the fresh air system and in communication with the adsorption rotary wheel E. The first heat exchanger C is disposed in the indoor air return pipe and/or the outdoor exhaust pipe. An outdoor air inlet pipe and an indoor air supply pipe are disposed at the air inlet side of the fresh air system and in communication with the adsorption rotary wheel E. The second heat exchanger D is disposed in the outdoor air inlet pipe and/or the indoor air supply pipe.

The above air conditioning system is a three-pipe heat-recovery multi-split system capable of realizing simultaneous cooling and heating. An outdoor unit is composed of the compressor 10 and the outdoor heat exchanger 20. An indoor unit is composed of the throttling device, the indoor heating heat exchanger 30, and the indoor cooling heat exchanger 40. The refrigerant circuit includes three refrigerant pipes and an MS refrigerant distributor B that connect the outdoor unit with the indoor unit. The MS refrigerant distributor is configured to control, through the refrigerant circuit, a refrigerant flow direction and a refrigerant flow rate in each of the indoor heating heat exchanger 30, the first heat exchanger C, the indoor cooling heat exchanger 40, and the second heat exchanger D. In some embodiments, the three refrigerant pipes are a high-pressure air pipe, a high-pressure liquid pipe, and a low-pressure liquid pipe, respectively. Refrigerant at corresponding temperatures among refrigerant in the three refrigerant pipes is delivered to a specified indoor heat exchanger through the MS refrigerant distributor B as required by a user.

With the rotary wheel humidity regulating device, switching of a number of operation modes such as a dehumidification mode and a humidification mode can be realized by controlling an operation mode and an operation temperature of each of the first heat exchanger C and the second heat exchanger D according to the indoor and outdoor air conditions.

A fresh air dehumidification mode will be described below.

As illustrated in FIG. 2, outdoor fresh air OA leads to a moisture absorption region. The outdoor fresh air OA first passes through the second heat exchanger D in the evaporation mode, and then is cooled down to a dew point, and even humidity of the outdoor fresh air OA is reduced to a predetermined value less than the dew point through condensation and dehumidification of the second heat exchanger D. Then, the outdoor fresh air OA is fully dehumidified to reach a predetermined state point after passing through the adsorption rotary wheel E, and finally is sucked by the air supply side fan F to be fed into the indoor space. After being heated by the first heat exchanger C in the condensation mode during air return, indoor return air RA at the other side is sucked by the air exhaust side fan G and discharged to the outside after passing through the adsorption rotary wheel E. In this process, the moisture stored in the adsorption rotary wheel E is discharged to the outside with the heated return air. Therefore, a whole operation cycle of the adsorption rotary wheel E is completed.

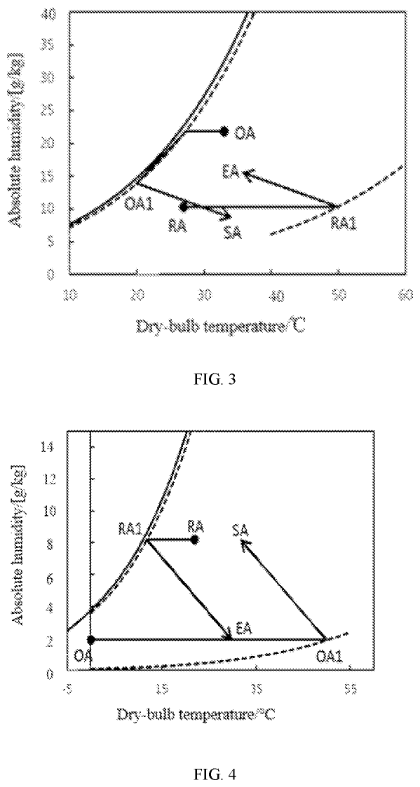

As illustrated in FIG. 3, the outdoor fresh air OA is condensed and dehumidified into OA1 through the second heat exchanger D, and then fed into the indoor space through a region of the adsorption rotary wheel E where it is dehumidified once again to an air supply state point SA. The indoor return air RA is heated into RA1 through the first heat exchanger C, and then regenerated through a desorption region of the adsorption rotary wheel E and has the moisture discharged outdoors along with the outdoor exhaust air EA. Outdoor fresh air OA at a dehumidification side controls a state of the OA1 by regulating an evaporation temperature of the second heat exchanger D, which enables a dehumidification amount of the adsorption rotary wheel E to be constant. Furthermore, the outdoor fresh air OA at the dehumidification side controls a state of the RA1 by regulating a condensation temperature of the first heat exchanger C in combination with a regeneration side and controls a state of the outdoor exhaust air SA by regulating a rotation speed of the adsorption rotary wheel E.

A fresh air humidification mode will be described below.

As illustrated in FIG. 2, the outdoor fresh air OA leads to the moisture absorption region. The outdoor fresh air OA first passes through the second heat exchanger D in the condensation mode and is heated, then is sucked by the air supply side fan F to be fed into the indoor space after passing through the adsorption rotary wheel E. During this process, the moisture stored in the adsorption rotary wheel E is fed into the indoor space with the heated outdoor fresh air OA, to realize the humidification. The indoor air RA at the other side is cooled down by the first heat exchanger C in the evaporation mode during the air return, relative humidity of the indoor air RA is raised to around 100%. As a result, it is easier for moisture in the return air to be adsorbed by the adsorption rotary wheel E, and is then sucked by the air exhaust side fan G and discharged outdoors. Therefore, the whole operation cycle of the adsorption rotary wheel E is completed.

As illustrated in FIG. 4, the outdoor fresh air OA is heated into OA1 through the second heat exchanger D, and then fed into the indoor space through a region of the adsorption rotary wheel E where it is humidified to an air supply state point SA. The indoor return air RA is cooled down into RA1 through the first heat exchanger C, then collects the moisture in the adsorption region of the adsorption rotary wheel E, and is discharged outdoors along with the outdoor exhaust air EA. The indoor return air RA at a moisture absorption side controls the state of the RA1 by regulating an evaporation temperature of the first heat exchanger C, which enables the relative humidity of the air entering the adsorption region of the adsorption rotary wheel E to be close to saturation. Therefore, efficiency of the absorption can be improved. Furthermore, the state of the OA1 is controlled by regulating a condensation temperature of the second heat exchanger D in combination with the outdoor fresh air OA at the humidification side, and the state of the outdoor exhaust air SA is controlled by regulating the rotation speed of the adsorption rotary wheel E.

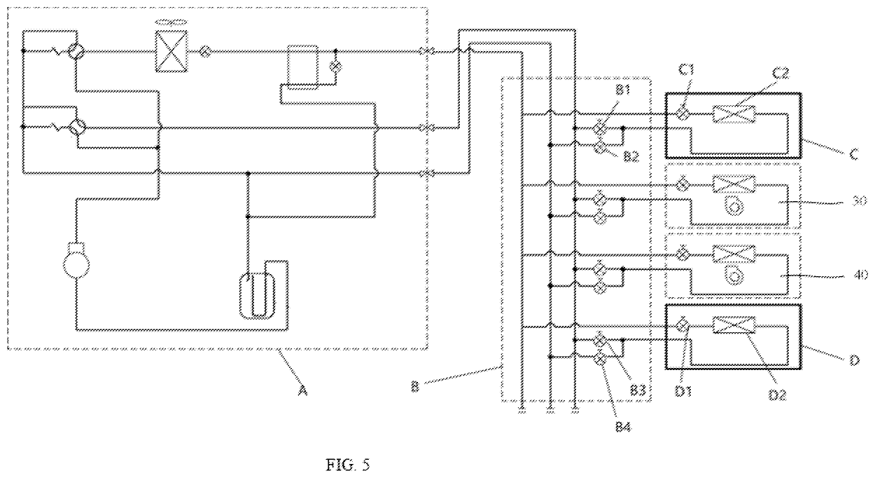

FIG. 5 is a schematic structural diagram of an air conditioning system according to the present disclosure. The refrigerant distributor B includes a first regulation valve device for connecting the outdoor unit A with the first heat exchanger C, and a second regulation valve device for connecting the outdoor unit A with the second heat exchanger D. The main components illustrated in the drawings are marked as follows. An outdoor unit is denoted by A. A refrigerant distributor is denoted by B, and electronic expansion valves are denoted by B1 to B4. A first heat exchanger is denoted by C. An electronic expansion valve is denoted by C1, and a heat exchanger body is denoted by C2. A second heat exchanger is denoted by D. An electronic expansion valve is denoted by D1, and a heat exchanger body is denoted by D2. The outdoor unit A is configured to be switched into a main cooling mode and a main heating mode based on an outdoor operation condition. A refrigerant flow direction to the indoor unit is switched through regulation of an opening degree of each of the electronic expansion valves B1 to B4 in the refrigerant distributor B. In this way, the first heat exchanger C and the second heat exchanger D can be ensured to operate in a cooling or heating mode as required by an anhydrous humidity regulation module. Meanwhile, the required evaporation temperature and condensation temperature are regulated through the electronic expansion valve C1 and the electronic expansion valve D1 at a side B of the indoor unit. In this case, a temperature of air passing through the first heat exchanger C and the second heat exchanger D is regulated, and normal diffusion of water vapor between different regions of the adsorption rotary wheel E is achieved. A first regulation valve device of the first heat exchanger C is composed of the electronic expansion valve B1, the electronic expansion valve B2, and the electronic expansion valve C1. A second regulation valve device of the second heat exchanger D is composed of the electronic expansion valve B3, the electronic expansion valve B4, and the electronic expansion valve D1.

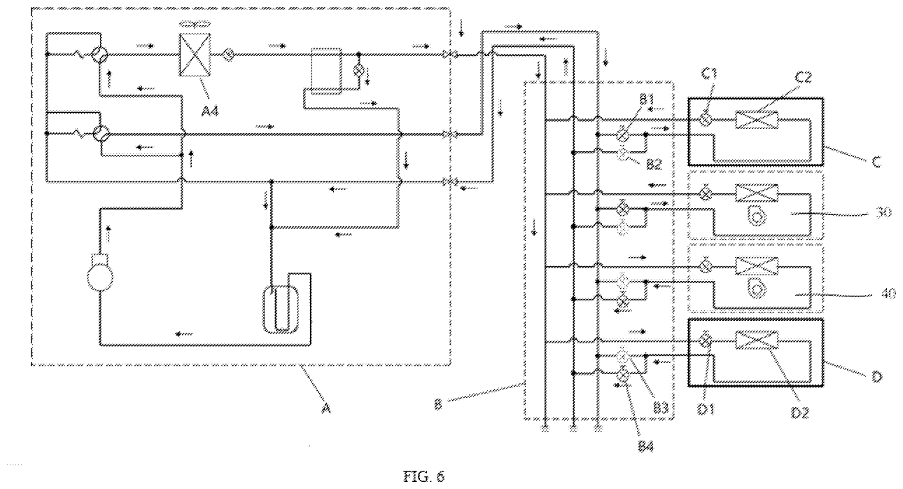

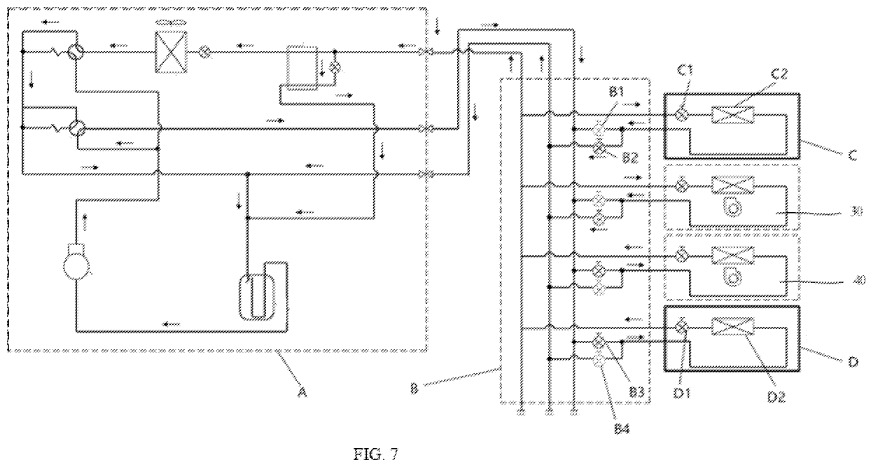

FIG. 6 is a diagram of a refrigerant system when the air conditioning system is in a main cooling mode. When an outdoor heat exchanger A4 is a condenser, the MS refrigerant distributor B has an electronic expansion valve B1 opened and an electronic expansion valve B2 closed. When the first heat exchanger C in the indoor unit B is in the condensation mode, the electronic expansion valve B3 is closed, the electronic expansion valve B4 is opened, and the second heat exchanger D is in the evaporation mode. At this time, the rotary wheel humidity regulating device is in the fresh air humidification mode. In addition, the operation mode of each of the first heat exchanger C and the second heat exchanger D can be changed by switching the opening degree of each of the electronic expansion valves of B1 to B4, which enables the operation mode of the rotary wheel humidity regulating device to be switched into the fresh air dehumidification mode illustrated in FIG. 7. Meanwhile, a refrigerant temperature in the first heat exchanger C and a refrigerant temperature in the second heat exchanger D may be controlled by regulating the opening degree of the electronic expansion valve C1 in front of the first heat exchanger C and the opening degree of the electronic expansion valve C2 in front of the second heat exchanger D. therefore, the effect of regulating the humidity and temperature can be realized.

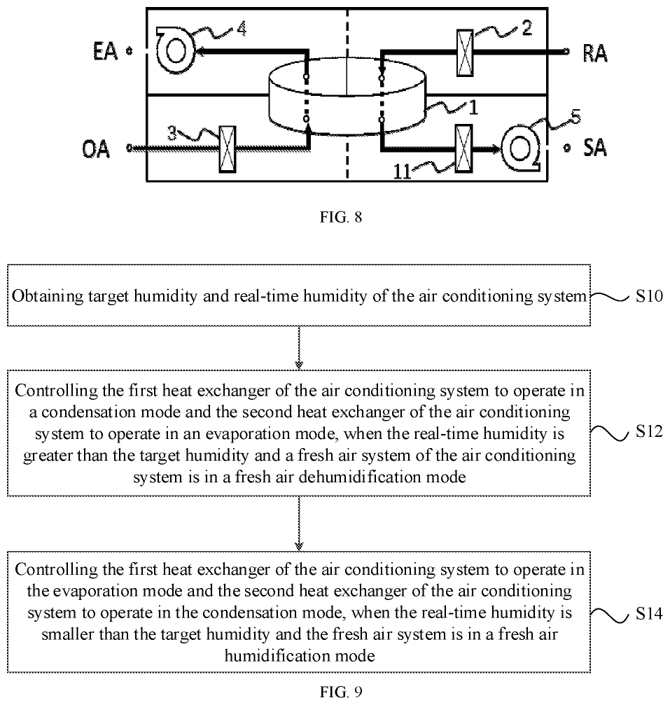

It should be noted that the rotary wheel humidity regulating device as described in the above embodiments has two heat exchangers. However, the number of heat exchangers in the rotary wheel humidity regulating device is not limited thereto. As illustrated in FIG. 8, in other embodiments of the present disclosure, three heat exchangers including a heat exchanger 11, a heat exchanger 2, and a heat exchanger 3 may also be arranged at an indoor side for further controlling and regulating an air supply temperature. This modification is also within the scope of the embodiments of the present disclosure. In addition, the fresh air system in the fresh air humidity regulation mode is explained in the above embodiments, and an air exchange system in a return air humidity regulation mode also falls within the scope of the embodiments of the present disclosure. Therefore, the air exchange system in the return air humidity regulation mode will be described in detail below.

A return air dehumidification mode of the air exchange system in the return air humidity humidification will be described below.

As illustrated in FIG. 8, the outdoor fresh air OA leads to an indoor moisture absorption region. The outdoor fresh air OA first passes through the heat exchanger 2 in the evaporation mode, and then is cooled down to the dew point, and even air humidity is reduced to the predetermined value through the condensation and dehumidification. Furthermore, the outdoor fresh air OA is fully dehumidified to reach the predetermined state point after passing through an adsorption rotary wheel 1, and finally is sucked by the air supply side fan 5 to be fed into the indoor space for an indoor air supply SA. After the outdoor fresh air OA at another side is heated by the heat exchanger 3 in the condensation mode, the outdoor fresh air OA at the other side is sucked by the air exhaust side fan 4 and discharged outdoors for an outdoor exhaust air EA after passing through the adsorption rotary wheel E. In this process, moisture stored in the adsorption rotary wheel 1 is discharged outdoors with the heated fresh air. Therefore, a whole operation cycle of the adsorption rotary wheel 1 is completed.

A return air humidification mode of the air exchange system in the return air humidity humidification will be described below.

The indoor return air RA leads to an indoor moisture liberation region. The indoor return air RA first passes through the heat exchanger 2 in the condensation mode and is heated, then is sucked by the air supply side fan 5 to be fed into the indoor space after passing through the adsorption rotary wheel 1. During this process, the moisture stored in the adsorption rotary wheel 1 is fed into the indoor space for the indoor air supply SA with the heated indoor return air RA, to realize humidification. The outdoor fresh air OA at the other side is cooled down by the heat exchanger 3 in the evaporation mode, and relative humidity is raised to about 100%. As a result, it is easier for moisture in the outdoor fresh air OA to be adsorbed by the adsorption rotary wheel 1, and is then discharged outdoors by the air exhaust side fan 4. Therefore, the whole operation cycle of the adsorption rotary wheel 1 is completed.

As illustrated in FIG. 9, according to one embodiment of the present disclosure, a control method for an air conditioning system is provided according to an embodiment of the present disclosure. The method includes actions at blocks S10 to S14.

At block S10, target humidity and real-time humidity of the air conditioning system are obtained.

At block S12, when the real-time humidity is greater than the target humidity and a fresh air system of the air conditioning system is in a fresh air dehumidification mode, the first heat exchanger of the air conditioning system is controlled to operate in a condensation mode, and the second heat exchanger of the air conditioning system is controlled to operate in an evaporation mode.

At block S14, when the real-time humidity is less than the target humidity and the fresh air system is in a fresh air humidification mode, the first heat exchanger of the air conditioning system is controlled to operate in the evaporation mode, and the second heat exchanger of the air conditioning system is controlled to operate in the condensation mode.

The first regulation valve device of the first heat exchanger C is composed of the electronic expansion valve B1, the electronic expansion valve B2, and the electronic expansion valve C1. The second regulation valve device of the second heat exchanger D is composed of the electronic expansion valve B3, the electronic expansion valve B4, and the electronic expansion valve D1.

According to an embodiment of the present disclosure, the operation of controlling the first heat exchanger of the air conditioning system to operate in the condensation mode further includes: obtaining a target temperature and a real-time temperature of an adsorption side of the adsorption rotary wheel of the air conditioning system; controlling, when the real-time temperature is greater than the target temperature, an opening degree of a first regulation valve device of the first heat exchanger to decrease, and in some embodiments, controlling an opening degree of the electronic expansion valve C1 of the first regulation valve device to decrease; and controlling, when the real-time temperature is less than the target temperature, the opening degree of the first regulation valve device of the first heat exchanger to increase, and in some embodiments, controlling an opening degree of the electronic expansion valve C1 of the first regulation valve device to increase.

According to an embodiment of the present disclosure, the operation of controlling the second heat exchanger of the air conditioning system to operate in the condensation mode further includes: obtaining a target temperature and a real-time temperature of an adsorption side of the adsorption rotary wheel of the air conditioning system; controlling, when the real-time temperature is greater than the target temperature, an opening degree of a second regulation valve device of the second heat exchanger to decrease, and in some embodiments, controlling an opening degree of the electronic expansion valve D1 of the second regulation valve device to decrease; and controlling, when the real-time temperature is less than the target temperature, the opening degree of the second regulation valve device of the second heat exchanger to increase, and in some embodiments, controlling an opening degree of the electronic expansion valve D1 of the second regulation valve device to increase.

According to an embodiment of the present disclosure, the control method for the air conditioning system further includes: controlling, when the real-time humidity is still greater than the target humidity, an opening degree of a second regulation valve device of the second heat exchanger to decrease, and in some embodiments, an opening degree of the electronic expansion valve B4 of the second regulation valve device to increase; and controlling, when the real-time humidity is still less than the target humidity, an opening degree of a first regulation valve device of the first heat exchanger to increase, and in some embodiments, an opening degree of the electronic expansion valve B1 of the first regulation valve device to increase.

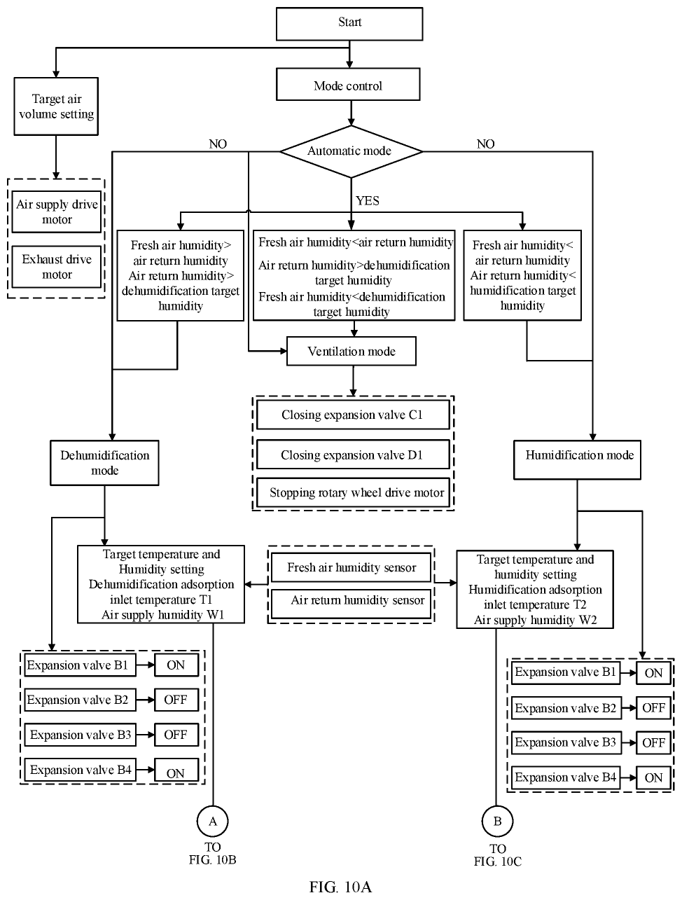

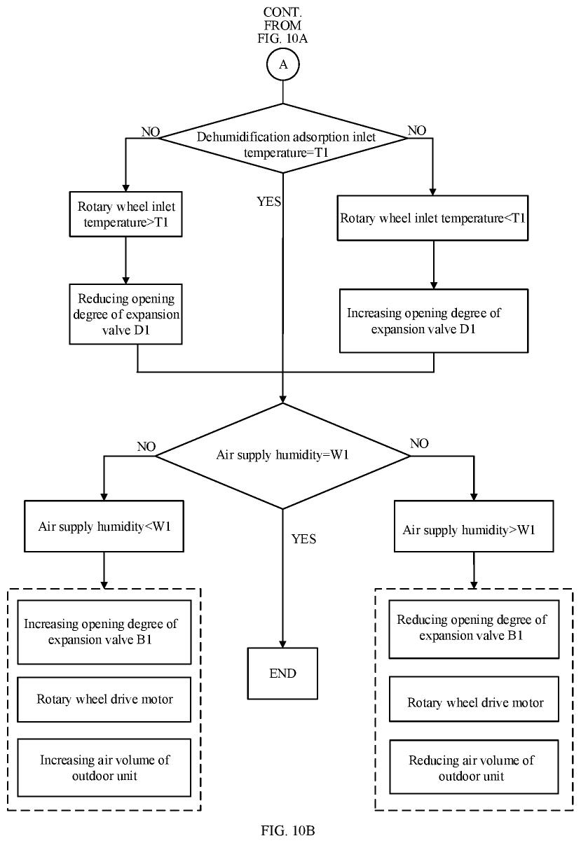

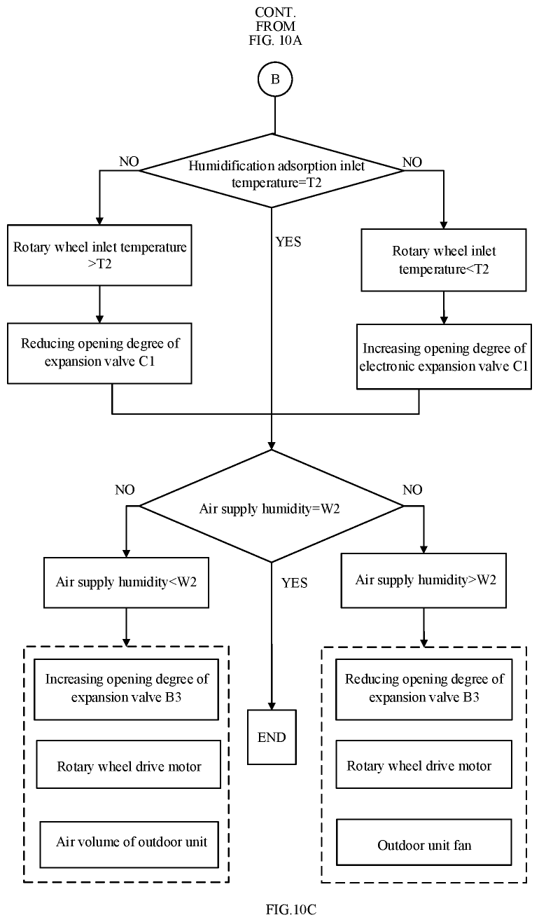

In order to describe the control method for the air conditioning system according to one embodiment of the present disclosure in detail and completely, FIG. 10 discloses a detailed flowchart of the control method for the air conditioning system. Specific steps of the control method for the air conditioning system disclosed in FIG. 10 are described in detail in the above embodiments, and the control method for the air conditioning system shown in FIG. 10 will be simply introduced below.

After the operation starts, an operation mode, a ventilation air volume, and a dehumidification/humidification operation mode are set based on a user input. In response to that an automatic mode is selected by the user, an operation mode of the rotary wheel humidity regulating device is automatically determined by fresh air humidity, return air humidity, and dehumidification target humidity.

Taking the humidification mode as an example, an adsorption inlet temperature Ti and air supply humidity W2 of the adsorption rotary wheel are detected by the controller based on target humidity set by the user, a fresh air humidity sensor, and a return air temperature and humidity sensor. Meanwhile, the first heat exchanger is in the evaporation mode and the second heat exchanger is in the condensation mode, and the opening degrees of the regulation valve devices B1 to B4 in the MS refrigerant distributor are correspondingly regulated. Furthermore, a temperature and humidity control module of the controller performs a calculation based on the target humidity and a detection value of the humidity sensor, operates based on a determination condition, and transmits an execution signal to a corresponding control unit. Therefore, it is possible to control the temperature and humidity.

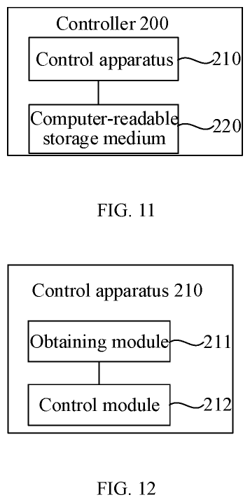

As illustrated in FIG. 11 and FIG. 12, a controller 200 is further provided according to one embodiment of the present disclosure. According to an embodiment, the controller 200 includes a control apparatus 210 and a computer-readable storage medium 220 having instructions stored thereon. The control apparatus 210 is configured to, when executing the instructions, perform the control method for the air conditioning system according to one embodiment of the present disclosure. The control apparatus includes: an obtaining module 211 configured to obtain target humidity and real-time humidity of the air conditioning system; a control module 212 configured to control a first heat exchanger of the air conditioning system to operate in a condensation mode and a second heat exchanger of the air conditioning system to operate in an evaporation mode, when the real-time humidity is greater than the target humidity and the fresh air system of the air conditioning system is in a fresh air dehumidification mode. The control module 212 is further configured to control the first heat exchanger of the air conditioning system to operate in the evaporation mode and the second heat exchanger of the air conditioning system to operate in the condensation mode, when the real-time humidity is less than the target humidity and the fresh air system is in a fresh air humidification mode.

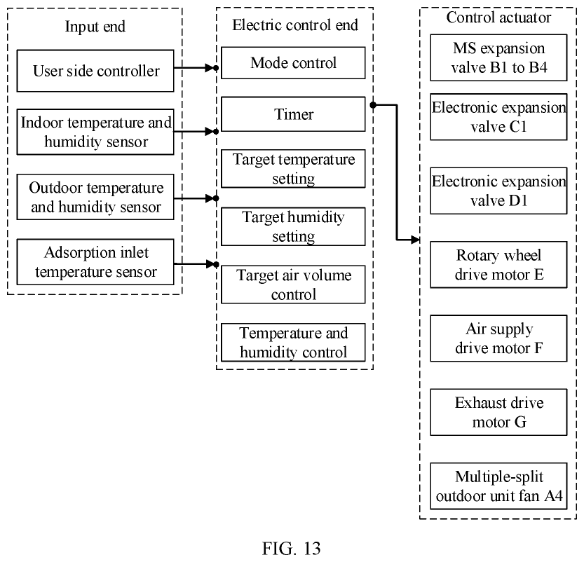

A specific control system of the air conditioning system is illustrated in FIG. 13. The whole control system is mainly composed of three parts including an input end, an electric control end, and a control actuator. A specific operation mode will be described below. Instruction and information are transmitted by an input end signal to the electric control end through a receiver and are processed by a built-in calculation program. An operation mode, time control, target temperature and humidity, target fresh air volume, and an actuator operation instruction which does not satisfy the target temperature and humidity are outputted. The operation mode of the first heat exchanger and the operation mode of the second heat exchanger are regulated by the control actuator. Therefore, the indoor to-be-conditioned air is regulated to reach the target temperature and humidity.

The input end includes a user-side controller, an indoor temperature and humidity sensor, an outdoor temperature and humidity sensor, and an adsorption inlet temperature sensor. The user-side controller such as a remote controller can transmit an operation mode to the device and sets instructions such as the target temperature and humidity, timing, and the target air volume. The adsorption inlet temperature sensor is configured to detect a temperature of air entering the adsorption side of the adsorption rotary wheel. Meanwhile, current indoor and outdoor air condition information is transmitted by the indoor temperature and humidity sensor and the outdoor temperature and humidity sensor to the electric control end.

The electric control end includes a mode control processor, a timer, a target temperature and humidity setter, a target air volume control module, and a temperature and humidity control calculation module. After receiving the information, the electric control end determines the operation mode, the target temperature and humidity, the target air volume, and an opening/closing and an opening value of each component reaching the target temperature and humidity through calculation processing. Finally, the respective operations are performed by the control actuator.

The control actuator includes MS expansion valves B1 to B4. The operation mode of the first heat exchanger and the operation mode of the second heat exchanger is controlled by adjusting an opening degree of each of the MS expansion valves B1 to B4, and a condensation temperature of the first heat exchanger and a condensation temperature of the second heat exchanger in a condensation operation mode is regulated. The electronic expansion valve C1 at the first heat exchanger side and the electronic expansion valve D1 at the second heat exchanger side are configured to regulate an evaporation temperature of the first heat exchanger and an evaporation temperature of the second heat exchanger in the evaporation mode. The rotary wheel drive motor E is configured to adjust the rotation speed of the adsorption rotary wheel and provide adjustment in exhaust air humidity control. The air supply drive motor F and the exhaust drive motor G are configured to adjust fresh air volume and exhaust air volume based on a user's instruction or an automatic air volume setting. In a normal operation process of the rotary wheel humidity regulating device, the indoor target temperature and humidity are controlled on the basis of a signal continuously inputted from the input end, the calculation processing of the electric control end, and the operations of the actuator.

Some embodiments of the present disclosure are described in detail above with reference to the accompanying drawings. However, the present disclosure is not limited to specific details in the above embodiments. Many simple variants can be made to the embodiments of the present disclosure within the scope of the present disclosure. These simple variants shall fall within the scope of the present disclosure.

In addition, it should be noted that the various specific features described in the above embodiments can be combined in any suitable manner without contradictions. In order to avoid unnecessary repetitions, various possible combinations will not be described separately in the present disclosure.

All or part of the steps of the method according to any of the above embodiments can be implemented by relevant hardware instructed by a program. The program is stored in a computer-readable storage medium 220 and includes several instructions for enabling one (which may be a single-chip microcomputer, a chip, or the like) or a control device 210 such as a processor to perform all or part of the steps of the method according to various embodiments of the present disclosure. The computer-readable storage medium 220 as described above includes various media that can store program codes, such as a USB flash disk, a mobile hard disk, a Read-Only Memory (ROM), a Random Access Memory (RAM), a magnetic disk, or an optical disc.

While some embodiments of the present disclosure have been described above, the scope of the present disclosure is not limited to these embodiments. Various variants and alternatives can be easily conceived, and shall fall within the scope of present disclosure. Therefore, the scope of the present disclosure shall be defined by the appended claims.

1. A rotary wheel humidity regulating device, comprising:
an adsorption rotary wheel having a first portion located at an air inlet side of a fresh air system of an air conditioning system and a second portion located at an air return side of the fresh air system;
a first heat exchanger disposed at a position on the air return side close to the second portion, the first heat exchanger being in communication with a refrigerant circuit of the air conditioning system and being controlled for cooling or heating by the air conditioning system through the refrigerant circuit; and
a second heat exchanger disposed at a position on the air inlet side close to the first portion, the second heat exchanger being in communication with the refrigerant circuit and being controlled for cooling or heating by the air conditioning system through the refrigerant circuit.

2. An air conditioning system, comprising:
a refrigerant circuit formed by a series connection of a compressor, an outdoor heat exchanger, a throttling device, and an indoor heat exchanger, the refrigerant circuit being in thermal contact with an indoor unit air circuit of the air conditioning system; and
a fresh air system comprising the rotary wheel humidity regulating device according to claim 1, the rotary wheel humidity regulating device being connected to the refrigerant circuit and the indoor unit air circuit.

3. The air conditioning system according to claim 2, wherein:
an indoor air return pipe and an outdoor exhaust pipe are disposed at the air return side of the fresh air system and in communication with the adsorption rotary wheel of the rotary wheel humidity regulating device, the first heat exchanger of the rotary wheel humidity regulating device being disposed in the indoor air return pipe and/or the outdoor exhaust pipe; and
an outdoor air inlet pipe and an indoor air supply pipe are disposed at the air inlet side of the fresh air system and in communication with the adsorption rotary wheel, the second heat exchanger of the rotary wheel humidity regulating device being disposed in the outdoor air inlet pipe.

4. The air conditioning system according to claim 2, wherein:
the indoor heat exchanger comprises an indoor heating heat exchanger and an indoor cooling heat exchanger;
an outdoor unit is composed of the compressor and the outdoor heat exchanger;
an indoor unit is composed of the throttling device, the indoor heating heat exchanger, and the indoor cooling heat exchanger;
the refrigerant circuit comprises three refrigerant pipes and a refrigerant distributor that connect the outdoor unit with the indoor unit; and
the refrigerant distributor is configured to control, through the refrigerant circuit, a refrigerant flow direction and a refrigerant flow rate in each of the indoor heating heat exchanger, the first heat exchanger, the indoor cooling heat exchanger, and the second heat exchanger.

5. The air conditioning system according to claim 4, wherein the refrigerant distributor comprises:
a first regulation valve device for connecting the outdoor unit with the first heat exchanger; and
a second regulation valve device for connecting the outdoor unit with the second heat exchanger.

6. A control method for an air conditioning system, the control method being implemented by the air conditioning system according to claim 2 and comprising:
obtaining target humidity and real-time humidity of the air conditioning system;
controlling the first heat exchanger of the air conditioning system to operate in a condensation mode and the second heat exchanger of the air conditioning system to operate in an evaporation mode, when the real-time humidity is greater than the target humidity and the fresh air system of the air conditioning system is in a fresh air dehumidification mode; and
controlling the first heat exchanger of the air conditioning system to operate in the evaporation mode and the second heat exchanger of the air conditioning system to operate in the condensation mode, when the real-time humidity is less than the target humidity and the fresh air system is in a fresh air humidification mode.

7. The control method for the air conditioning system according to claim 6, wherein said controlling the first heat exchanger of the air conditioning system to operate in the condensation mode comprises:
obtaining a target temperature and a real-time temperature of an adsorption side of the adsorption rotary wheel of the air conditioning system;
controlling, when the real-time temperature is greater than the target temperature, an opening degree of a first regulation valve device of the first heat exchanger to decrease; and
controlling, when the real-time temperature is less than the target temperature, the opening degree of the first regulation valve device of the first heat exchanger to increase.

8. The control method for the air conditioning system according to claim 6, wherein said controlling the second heat exchanger of the air conditioning system to operate in the condensation mode comprises:
obtaining a target temperature and a real-time temperature of an adsorption side of the adsorption rotary wheel of the air conditioning system;
controlling, when the real-time temperature is greater than the target temperature, an opening degree of a second regulation valve device of the second heat exchanger to decrease; and
controlling, when the real-time temperature is less than the target temperature, the opening degree of the second regulation valve device of the second heat exchanger to increase.

9. The control method for the air conditioning system according to claim 6, further comprising:
controlling, when the real-time humidity is still greater than the target humidity, an opening degree of a second regulation valve device of the second heat exchanger to increase; and
controlling, when the real-time humidity is still less than the target humidity, an opening degree of a first regulation valve device of the first heat exchanger to increase.

10. (canceled)

11. The control method for the air conditioning system according to claim 6, wherein:
an indoor air return pipe and an outdoor exhaust pipe are disposed at the air return side of the fresh air system and in communication with the adsorption rotary wheel of the rotary wheel humidity regulating device, the first heat exchanger of the rotary wheel humidity regulating device being disposed in the indoor air return pipe and/or the outdoor exhaust pipe; and
an outdoor air inlet pipe and an indoor air supply pipe are disposed at the air inlet side of the fresh air system and in communication with the adsorption rotary wheel, the second heat exchanger of the rotary wheel humidity regulating device being disposed in the outdoor air inlet pipe.

12. The control method for the air conditioning system according to claim 6, wherein:
the indoor heat exchanger comprises an indoor heating heat exchanger and an indoor cooling heat exchanger;
an outdoor unit is composed of the compressor and the outdoor heat exchanger;
an indoor unit is composed of the throttling device, the indoor heating heat exchanger, and the indoor cooling heat exchanger;
the refrigerant circuit comprises three refrigerant pipes and a refrigerant distributor that connect the outdoor unit with the indoor unit; and
the refrigerant distributor is configured to control, through the refrigerant circuit, a refrigerant flow direction and a refrigerant flow rate in each of the indoor heating heat exchanger, the first heat exchanger, the indoor cooling heat exchanger, and the second heat exchanger.

13. The control method for the air conditioning system according to claim 12, wherein the refrigerant distributor comprises:
a first regulation valve device for connecting the outdoor unit with the first heat exchanger; and
a second regulation valve device for connecting the outdoor unit with the second heat exchanger.
